(19) United States
(12) Patent Application Publication
(10) Pub. No.: US 2011/0102126 A1
(43) Pub. Date: May 5, 2011

(54) Thermostat

(75) Inventor: HaeYang Chung, Gyeonggi-do (KR)

(73) Assignee: Hanbecthistem Co., Ltd., Gyeonggi-do (KR)

(21) Appl. No.: 12/750,611

(22) Filed: Mar. 30, 2010

(30) Foreign Application Priority Data
Oct. 30, 2009 (KR) 10-2009-0104436
Feb. 3, 2010 (KR) 10-2010-0009897

(51) Int. Cl. H01H 37/04; H01H 37/52

(52) U.S. Cl. 337/372

(57) ABSTRACT

Disclosed is a thermostat comprising: a case; first and second fixed terminals passing through the bottom surface of the case and protruding to the outside; first and second fixed contact points connected to the first and second fixed terminals and installed within the case; a bimetal having a support hole at a central portion thereof and having a first movable contact point contactable with the first fixed contact point and a second movable contact point contactable with the second fixed contact point, the bimetal having a reversible curve; a fixed plate fixing the bimetal to the case and from which an adjustor supporting a central portion of the bimetal protrudes; a fixing means for fixing the bimetal to a central portion of the fixed plate; and a cover covering the top surface of the case.

### CROSS-REFERENCE TO RELATED APPLICATION

This application claims priority to and the benefit of Korean Patent Application No. 2009-0104436, filed on Oct. 30, 2009 and Korean Patent Application No. 2010-0009897, filed on Feb. 3, 2010, the disclosures of which are incorporated herein by reference in its entirety.

### BACKGROUND

1. Field of the Invention

The present invention relates to a thermostat, and more particularly to a bimetal type thermostat which enables an operation point of a bimetal to be easily set without employing a complex structure or process such as screwing.

2. Discussion of Related Art

In general, although electrically powered devices are safely operated by a certain range of currents or within a certain range of temperatures during a normal operation, they may be damaged or a fire may be caused when an over-current is supplied to them due to an abnormal operation of them. In order to solve the above problems, Japanese Utility Model Laid-Open No. 1985-183349 (hereinafter, referred to as “prior art”) discloses a thermostat.

As illustrated in FIGS. 1A and 1B, the thermostat according to the prior art includes a case 1, fixed terminals 9 and 10 having fixed contact points 7 and 8 respectively at tip ends thereof and passing through the bottom surface of the case 1 so as to protrude to the outside, a disk-shaped bimetal 5 having a hole at a central portion thereof and having movable contact points 3 and 4 so as to be contactable with the fixed contact points 7 and 8 respectively, the bimetal 5 having a reversible curve, and an adjustor 6 one end of which is fixed to the case 1, the adjustor 6 extending toward the interior of the case 1 and having a head 15, and a spring 13 pushing the bimetal 5 toward the head 15.

FIG. 1A shows an electrically connected state in which the bimetal 5 is not operated, and FIG. 1B shows an electrically disconnected state in which the bimetal 5 is operated.

The case 1 is covered by a cover 2, which defines an interior space.

The thermostat according to the prior art is mounted to a compressor motor of, for example, a refrigerator or an air conditioner, and if an over-current flows through the bimetal 5, heat emitted by the bimetal 5 itself increases.

If the temperature of the bimetal 5 which is increased by the heat emitted by the bimetal 5 itself reaches a reverse operation temperature, the bimetal 5 is rapidly reversed and the movable contact points 3 and 4 are separated from the fixed contact points 7 and 8, interrupting a current flow to an electrical device.

Meanwhile, if the temperature of the bimetal 5 reaches a returning operation temperature, the bimetal 5 rapidly performs a returning operation to return to its original state and the movable contact points 3 and 4 contact with the fixed contact points 7 and 8 again to allow current flows to the electrical device.

However, although the thermostat disclosed in the prior art adjusts the operation point of the bimetal 5 so that it can be applied to various electronic devices having different power consumptions, and different temperature and current characteristics, the operation point of the bimetal 5 cannot be accurately adjusted.

That is, since safety needs to be secured through a test for determining whether or not a current is interrupted in a desired condition after the operation point of the bimetal 5 is adjusted, it is inconvenient.

Meanwhile, if a test is not performed after the operation point of the bimetal 5 is adjusted, the bimetal 5 interrupts a current at a time earlier than a desired current interrupting condition, hampering smooth use of an electronic device. Furthermore, if the bimetal 5 fails to interrupt a current at a desired current interrupting condition, an over-current is supplied to an electronic device to damage it or cause a fire due to overheating.

In addition, since the structure and assembly for adjusting the operation point of the bimetal 5 are so complex and underproductive, and are unreliable due to unsuitable manufacturing/assembling processes.

### SUMMARY OF THE INVENTION

The prevent invention has been made in an effort to solve the above-described problems associated with the prior art, and an object of the present invention is to provide a thermostat which enables the operation point of a bimetal to be easily set.

It is another object of the present invention to provide a thermostat which has improved assembly efficiency and reliability.

According to an aspect of the present invention for achieving the above object, there is provided a thermostat comprising: a case; first and second fixed terminals passing through the bottom surface of the case and protruding to the outside; first and second fixed contact points connected to the first and second fixed terminals and installed within the case; a bimetal having a support hole at a central portion thereof and having a first movable contact point contactable with the first fixed contact point and a second movable contact point contactable with the second fixed contact point, the bimetal having a reversible curve; a fixed plate fixing the bimetal to the case and from which an adjustor supporting a central portion of the bimetal protrudes; a fixing means for fixing the bimetal to a central portion of the fixed plate; and a cover covering the top surface of the case, the height of the protruding portion of the adjustor being minutely adjusted to adjust an operation point of the bimetal.

An insert hole may be formed in the case, and an insert portion corresponding to the insert hole may be formed in the fixed plate, and one or both of the insert hole and the insert portion may be formed with a catching step.

An opening whose width becomes narrower may be formed at a central portion of the insert portion, and a pressing portion inserted into the opening may be formed within the insert hole.

The fixed plate may be formed with a stopper for restricting a reversing operation of the bimetal.

A guide groove may be formed in the case and a guide corresponding to the guide groove may be formed in the bimetal.

The case may be formed of heat-resisting ceramic, thermosetting plastic, or heat-resisting plastic.

At least one slit radially extending from the support hole may be formed in the bimetal.

An auxiliary hole whose diameter is smaller than that of the support hole may be formed at an end of the slit.

According to the present invention, an operation point of the bimetal can be set by minutely adjusting the adjustor of the fixed plate, the thermostat can be applied to various electrical devices having different power consumptions and temperature and current characteristics.

That is, the possibility of generation of unsuitable items can be reduced and reliability can be secured by eliminating the non-standardized processes of the prior art.

Furthermore, since the bimetal and the fixed plate constitute an assembly using a rivet, the thermostat can be mass-produced with a certain size so that it can be general-purposed, productive, and efficiently assembled.

### BRIEF DESCRIPTION OF THE DRAWINGS

The above and other objects, features and advantages of the present invention will become more apparent to those of ordinary skill in the art by describing in detail an exemplary embodiment thereof with reference to the accompanying drawings, in which:

FIGS. 1A and 1B are sectional views illustrating a conventional thermostat;

FIG. 2 is an exploded perspective view illustrating a thermostat according to an embodiment of the present invention;

FIG. 3 is a perspective view illustrating a thermostat according to the embodiment of the present invention;

FIG. 4 is a sectional view taken along line a-a of FIG. 3; and

FIG. 5 is a sectional view taken along line b-b of FIG. 3.

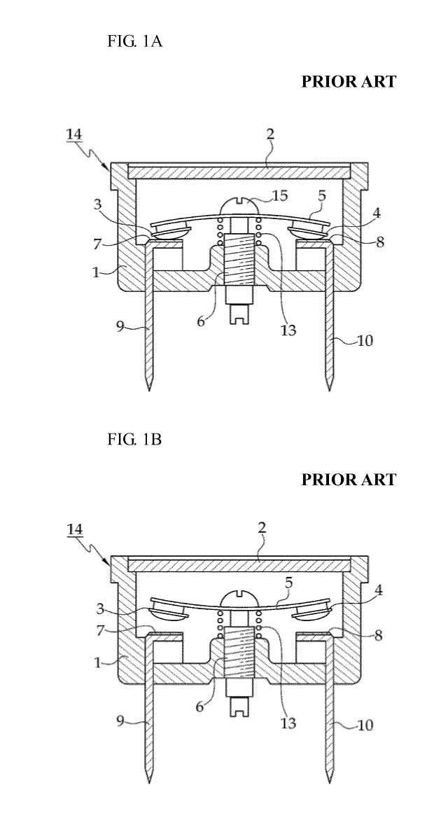

### DETAILED DESCRIPTION OF EXEMPLARY EMBODIMENTS

Hereinafter, an exemplary embodiment of the present invention will be described below in detail with reference to the accompanying drawings.

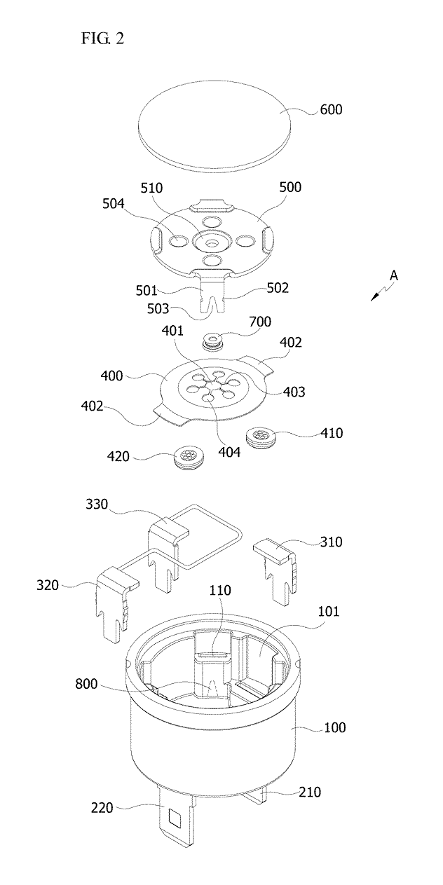

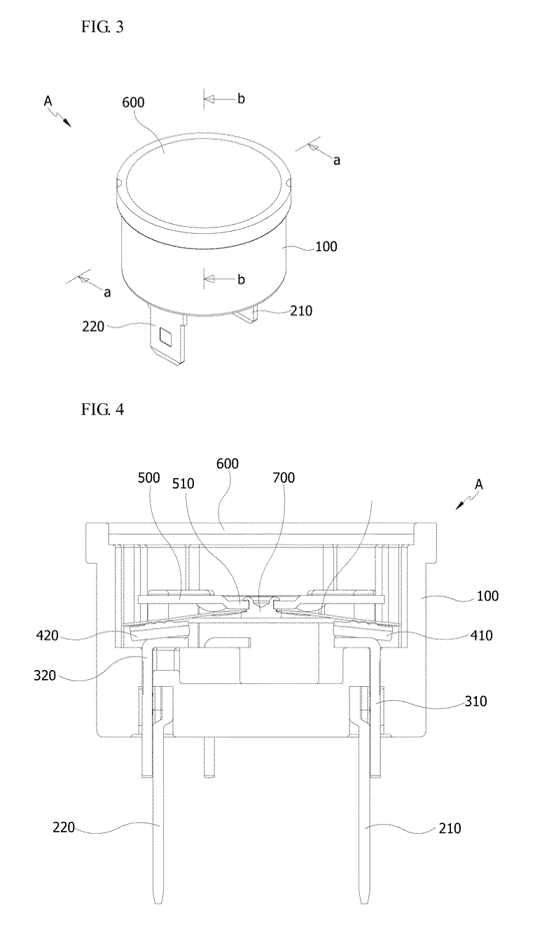

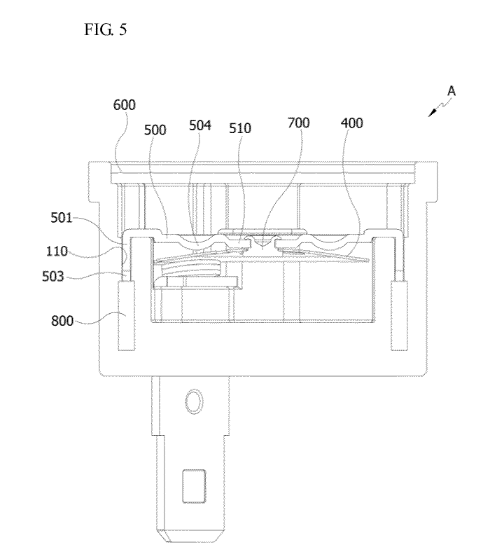

FIG. 2 is an exploded perspective view illustrating a thermostat according to an embodiment of the present invention. FIG. 3 is a perspective view illustrating a thermostat according to the embodiment of the present invention. FIG. 4 is a sectional view taken along line a-a of FIG. 3. FIG. 5 is a sectional view taken along line b-b of FIG. 3.

As illustrated in FIGS. 2 and 3, the thermostat A according to the embodiment of the invention includes a case 100, first and second fixed terminals 210 and 220 passing through the bottom surface of the case 100 and protruding to the outside, first and second fixed contact points 310 and 320 connected to the first and second fixed terminals 210 and 220 and fixed to the case 100, a bimetal 400 having a reversible curve and electrically connecting or disconnecting the first and second fixed contact points 310 and 320, a fixed plate 500 for fixing the bimetal 400, and a cover 600 covering an opened end of the case 100.

First, a support hole 401 is formed at a central portion of the bimetal 400, and a first movable contact point 410 contactable with the first fixed contact point 310 and a second movable contact point 420 contactable with the second fixed contact point 320 are formed in the bimetal 400.

An adjustor 510 for supporting a central portion of the bimetal 400 protrudes from the fixed plate 500 such that the operation point of the bimetal 400 can be adjusted according to the height of the protruding portion of the adjustor 510. Then, as illustrated in FIG. 4, the adjustor 510 is stepped downward with respect to the horizontal plane of the fixed plate 500. Meanwhile, the adjustor 510 is arc-shaped to protrude downward with respect to the fixed plate 500.

For example, if a central portion of the curved bimetal 400 is pushed deep by the adjustor 510, the curve of the bimetal 400 is rapidly reversed such that the bimetal 400 is operated at a low current or at a low temperature. Meanwhile, if a central portion of the bimetal 400 is not pushed deep, the bimetal 400 is slowly reversed such that the bimetal 400 interrupts a current at a high current or a high temperature.

Accordingly, the operation point of the bimetal 400 can be easily adjusted by the adjustor 510 of the fixed plate 500 such that the thermostat according to the invention can be applied to various types of electrical devices having different power consumptions and different temperature and current characteristics.

That is, although a safety needs to be tested after an operation point of an assembled bimetal is adjusted in the prior art, safety can be secured in advance through a test for determining whether a current is interrupted in a desired condition before an assembling process.

For example, safety according to an operation point of the bimetal 400 can be secured before an assembling process of the thermostat A to prevent the thermostat A from malfunctioning.

The bimetal 400 and the fixed plate 500 are coupled to each other by a fixing means 700. The fixing means 700 is preferably riveting.

Meanwhile, the fixing means 700 may include a general mechanical coupling means such as pressure welding or welding in addition to riveting.

Accordingly, since the bimetal 400 and the fixed plate 500 constitute an assembly using a rivet, the thermostat A can be mass-produced with a certain size so that it can be general-purposed, productive, and efficiently assembled.

For example, the assembly of the bimetal 400 whose operation point can be set according to the rated capacity of an applied electrical device and the fixed plate 500 can be exchanged, enabling mass-production and low manufacturing costs.

Insert holes 110 are formed in the case 100 and insert portions 501 corresponding to the insert holes 110 are formed in the fixed plate 500. Catching steps 502 are formed in the insert portions 501 respectively.

An opening 503 whose width becomes narrower is formed at a central portion of each insert portion 501, and a pressing portion 800 inserted into the opening 503 is formed within each insert hole 110 to widen the opening 503 widthwise.

Accordingly, the pressing portion 800 widens the opening 503 widthwise so that the fixed plate 500 can be firmly fixed to the case 100 with the insert potions 501 being inserted into the insert holes 110.

Stoppers 504 for restricting the reversing operation of the bimetal 400 are formed in the fixed plate 500 to prevent the bimetal 400 from being reversed excessively. That is, the bimetal 400 is prevented from slowly returning to its original shape due to excessive reversal of the bimetal 400.

Guide grooves 101 are formed in the case 100 and guides 402 corresponding to the guide grooves 101 are formed in the bimetal 400 to enhance assembling efficiency.

Meanwhile, at least one slit 403 radially extending from the support hole 401 is formed in the bimetal 400, and an auxiliary hole 404 whose diameter is smaller than that of the support hole 401 is formed at an end of the slit 403.

The reversing and returning operations of the bimetal 400 can be smoothly performed by the slits 403 and the auxiliary holes 404 to minimize metal fatigue.

The bimetal 400 is formed of a material which is well known in the field.

The case 100 is preferably formed of heat-resisting ceramic, thermosetting plastic, or heat-resisting plastic.

Meanwhile, a ground contact point 330 is connected to the second fixed contact point 320.

It will be apparent to those skilled in the art that various modifications can be made to the above-described exemplary embodiment of the present invention without departing from the spirit or scope of the invention. Thus, it is intended that the present invention covers all such modifications provided they come within the scope of the appended claims and their equivalents.

For example, although the first and second fixed terminals 210 and 220 and the first and second fixed contact points 310 and 320 are illustrated and explained as separate parts, the present invention is not limited thereto but they may be formed integrally.

What is claimed is:

1. A thermostat comprising:
a case;
first and second fixed terminals passing through the bottom surface of the case and protruding to the outside;
first and second fixed contact points connected to the first and second fixed terminals respectively and installed within the case;
a bimetal having a support hole at a central portion thereof and having a first movable contact point contactable with the first fixed contact point and a second movable contact point contactable with the second fixed contact point, the bimetal having a reversible curve;
a fixed plate fixing the bimetal to the case and from which an adjustor supporting a central portion of the bimetal protrudes;
a fixing means for fixing the bimetal to a central portion of the fixed plate; and
a cover covering the top surface of the case,
wherein the height of the protruding portion of the adjustor is minutely adjusted to adjust an operation point of the bimetal.

2. The thermostat of claim 1, wherein an insert hole is formed in the case, an insert portion corresponding to the insert hole is formed in the fixed plate, and one or both of the insert hole and the insert portion are formed with a catching step.

3. The thermostat of claim 2, wherein an opening whose width becomes narrower is formed at a central portion of the insert portion, and a pressing portion inserted into the opening is formed within the insert hole.

4. The thermostat of claim 1, wherein the fixed plate is formed with a stopper for restricting a reversing operation of the bimetal.

5. The thermostat of claim 1, wherein a guide groove is formed in the case and a guide corresponding to the guide groove is formed in the bimetal.

6. The thermostat of claim 1, wherein the case is formed of heat-resisting ceramic, thermosetting plastic, or heat-resisting plastic.

7. The thermostat of claim 1, wherein at least one slit radially extending from the support hole is formed in the bimetal.

8. The thermostat of claim 7, wherein an auxiliary hole whose diameter is smaller than that of the support hole is formed at an end of the slit.
